(19) United States
(12) Patent Application Publication
(10) Pub. No.: US 2025/0024349 A1
(43) Pub. Date: Jan. 16, 2025

(54) MITIGATING THE EFFECTS OF OPTIMAL JAMMING ATTACKS USING A PREDICTIVE DIGITAL TWIN MODULE

(71) Applicant: Dell Products L.P., Round Rock, TX (US)

(72) Inventors: Maira Beatriz Hernandez Moran, Rio de Janeiro (BR); Eduarda Tatiane Caetano Chagas, Belo Horizonte (BR); Paulo Abelha Ferreira, Rio de Janeiro (BR)

(21) Appl. No.: 18/352,804

(22) Filed: Jul. 14, 2023

(51) Int. Cl. H04W 40/34; H04W 40/24

(52) U.S. Cl. CPC H04W 40/34; H04W 40/246

(57) ABSTRACT

One example method includes receiving, by an anti-jamming module, information indicating that nodes of a communication network are unreachable, determining, by the anti-jamming module, whether the nodes match with nodes expected to be affected by an anticipated jamming attack, when the nodes match with the nodes expected to be affected by the anticipated jamming attack, providing, by the anti-jamming module, communication network route changes to a network monitoring module, and when the nodes do not match with the nodes expected to be affected by the anticipated jamming attack, calculating, by the anti-jamming module, other communication network route changes, and providing the other communication network route changes to the network monitoring module.

### FIELD OF THE INVENTION

Embodiments of the present invention generally relate to network security. More particularly, at least some embodiments of the invention relate to systems, hardware, software, computer-readable media, and methods, for handling actual, and anticipated, jamming attacks in edge networks.

### BACKGROUND

Recently, wireless networks have evolved substantially, and consequently, security threats in this scenario have become a big concern. Compared to other security threats, wireless networks, including mobile ones, are particularly vulnerable to jamming attacks. This type of attack consists of intentionally emitting powerful signal into the physical environment to affect the transmission in the wireless network. As a result, nodes in the network become inaccessible, and the transmission between and among nodes is interrupted, or prevented. In order to reestablish the transmission, the routing paths must be recalculated considering the nodes that remain available. However, this has proven difficult.

Particularly, a significant challenge is to provide resilience against jamming attacks in wireless networks, so the effects of such attacks can be reduced. Current approaches to addressing this problem have long response times, and demand substantial network and memory resources in the nodes.

The main objective of jammers, in an optimal approach, is to maximize the effect of the attacks by compromising the largest number of nodes as possible. This attack vector may imply an optimization problem, where the position of the jammer and the channels in which the noise signals are emitted determine the efficiency of the attack. However, current approaches do not provide the capability to anticipate such optimal jamming attacks. That is, conventional approaches operate only in a reactive mode.

Moreover, reestablishing communication during, or after, a jamming attack is challenging. In a wireless network, when a set of nodes used as part of the route for data transmission is unreachable, due to a jamming attack for example, the transmission its interrupted. In order to reestablish the communication, alternative transmission routes can be defined avoiding the unreachable nodes. It is also possible that the jamming attack has only affected specific channels, so the route could be maintained only changing the used channel. However, more sophisticated attacks can alternate between channels to improve attack efficiency. On the other hand, the location of the jammer is a physical aspect that cannot be easily changed. Therefore, defense strategies that implement new transmission routes tend to be more successful.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a B5GEMINI architecture.

FIG. 2 discloses an overview of one example embodiment.

FIG. 3 discloses aspects of interaction between an anti-jamming module and a B5GEMINI architecture.

FIG. 4 discloses aspects of an example method according to one embodiment.

FIG. 5 discloses aspects of an example computing entity configured and operable to perform any of the disclosed methods, processes, and operations.

### DETAILED DESCRIPTION OF SOME EXAMPLE EMBODIMENTS

Embodiments of the present invention generally relate to network security. More particularly, at least some embodiments of the invention relate to systems, hardware, software, computer-readable media, and methods, for handling actual, and anticipated, jamming attacks in edge networks. One example edge network is a mobile communications network, such as a cellular network. More generally, an embodiment of the invention may be employed in, but are not limited to, any environment in which one or more nodes communicate with each other using radio frequency (RF) signals.

In one example embodiment of the invention, a digital twin (DT) platform is extended to include a module that comprises an anti-jamming solution operable to detect ongoing attacks that were previously anticipated, and to implement quick responses for these attacks and so minimize their effects. In more detail, the state of a physical network may be cloned, and the ‘k’ most successful optimal jamming attacks defined for that physical network. The nodes of the physical network anticipated to be affected by the optimal jamming attack may be identified, and alternate communication routes in the physical network may be devised that may avoid the affected nodes. Thus, when the optimal attack is detected, the alternate routes may be immediately put into use.

In an embodiment, a sub-optimal attack may not be anticipated, such that no alternative routes have been defined prior to that attack. Thus, the alternative routes may be defined in real-time in reaction to the attack. However, the impact of such a sub attack may be expected to be low, since if the attack was not anticipated, the attack may be sub-optimal and thus not of great concern. In this case, the attack may not significantly damage communications in the network during the time in which the reactive defense is being implemented.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect an embodiment of the invention is that an attack on a communication network, such as an optimal attack, may be anticipated and thus enable development of a solution to the attack before the attack actually takes place. An embodiment of the invention may enable implementation and use of optimal, in the context of a particular attack, alternative communication routes in a network as the attack is occurring. Various other advantages of some example embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment of the Invention

As noted earlier herein, wireless networks have evolved substantially, and consequently, security threats, such as jamming attacks, have become a significant concern. This type of attack typically involves intentionally emitting powerful signal into the physical environment to affect the transmission in the wireless network. As a result, nodes in the network become inaccessible, and the transmission is interrupted. In order to reestablish the transmission, the routing paths must be recalculated considering the nodes that remain available and unaffected by the attack. Thus, several routing-based solutions have been proposed to deal with jamming attacks. In large networks, most solutions consist of detecting an attack and then reconfiguring the communication with the established defense strategy, which can cause a delay in communications within the network. While proactively changing routing paths aids in preventing major damage, this approach demands significant network resources and may not be feasible in many circumstances.

Mobile networks, in particular, often handle large amounts of heterogeneous data that differ greatly in format and content. Therefore, creating a model of the network that accurately represents its behavior is a highly challenging task. Recently, some Digital Twin (DT) approaches have emerged that focus on modelling mobile networks considering security issues. DT may be described as a digital representation of a real-world entity or system. An aggregation of data from multiple digital twins may be used to compose a view of different real-world entities and their processes. In this way, this technology may also be employed to simulate digital systems and their dynamics to evaluate risks and possible attacks.

Thus, one or more embodiments may address challenges such as these by anticipating the occurrence of optimal jamming attacks, and reestablishing communication during and/or after a jamming attack. To these ends, one example embodiment may employ a DT platform, such as is disclosed in Mozo, Alberto, et al. “B5GEMINI: AI-Driven Network Digital Twin.” Sensors 22.11 (2022): 4106 (‘Mozo’), which is incorporated herein in its entirety by this reference.

In general, Mozo discloses B5GEMINI, a DT architecture, whose main objective is to deploy a 5G/6G DT system capable of mirroring different network configurations and analyzing activities focusing on cybersecurity aspects. However, the Mozo approach does not disclose or employ methods for identifying anticipated, optimal, jamming attacks, nor a defense strategy for dealing with such optimal jamming attacks. In an embodiment, a DT architecture, such as B5GEMINI for example, is extended to include a module to handle jamming attacks. Thus, an example embodiment may comprise a DT system or architecture that is configured and operable to infer and anticipate optimal jamming attacks during the monitoring of a communication network and also establish and implement defense strategies for minimizing the effects of such attacks when they occur.

### B. Aspects of Some Jamming Attacks

Wireless networks present a major potential to facilitate communication and data transmission, and have become very popular in recent years. However, since air is the medium through which these communications, such as data transmission, occur, this type of network is susceptible to jamming attacks. In general, a jamming attack involves disrupting the data transmission in wireless networks by emitting radio signals to the medium, air in this example. When a jamming device with enough power is tuned to the same frequency and type of modulation as the target receiving equipment of the network, the jamming device can override any signal at this target.

For measuring the transmission potential of devices in wireless networks, the Signal-to-Inference-plus-Noise ratio (SINR) can be used. This metric indicates a ratio of the signal power to the sum of the interference power from other interfering signals and noise power. A ratio greater than 1 indicates that there is more signal than noise, which is an ideal scenario, at least in some circumstances. On the other hand, the lower the SINR value, the greater the interference of the noise in the transmission.

Jamming attacks may differ significantly, depending on how they are implemented. A jamming attack may be constant, such as when the attacker broadcasts a powerful signal all the time to a fixed set of targets, considering the entire or a fraction of the channel bandwidth occupied by legitimate users. Another type of jamming attack is the reactive jamming attack, also sometimes referred to as channel-aware jamming attack, in which the attacker emits an interfering radio signal when it detects legitimate packets being transmitted. That is, this attack is active only when there are data transmissions occurring in the network. This type of attack requires tight timing constraints to be efficient. In both random and periodic jamming attacks, the attacker sends jamming signals for random periods and goes to sleep when jamming signals are not being sent. Furthermore, there are other types of jamming attacks that follow other established strategies such as sweeping targets and channels in a defined order, for example. For practical purposes, the effect of such jamming attacks is always to interrupt the communication to a set of target devices, so that those devices become unreachable for other nodes in the wireless network. The different strategies can improve or decrease the attack efficacy.

Some defense strategies for this type of attack include reconfiguring the wireless network in order to reestablish the data transmission that was interrupted due to the attack. This may be done, for example, by trying to transmit on other channels in the network that might be not affected by the attack, or even defining alternative transmission routes in the network that avoid the nodes affected by the attack. In large networks, typical solutions are reactive and consist of detecting an attack and then reconfiguring the communication to reestablish the transmission, which can cause a delay in communication. On the other hand, proactive defenses actively change the network configuration, such as in terms of communications routing or channels used, to prevent major damage when an attack occurs. However, this approach demands significant network resources.

### C. Aspects of an Example DT Architecture

As noted herein, Mozo discloses B5GEMINI, an AI-driven network digital twin (DT) architecture whose main objective is to deploy a 5G/6G DT system capable of mirroring different network configurations. In an example embodiment, the structure and functionalities provided by B5GEMINI enable the monitoring and analysis of activities focusing on cybersecurity aspects. Moreover, this architecture promotes a realistic experimentation environment, so simulations can be performed considering the behavior of real-world physical environments. B5GEMINI also presents capability for a two-way communication with the real/physical network, providing real-time synchronization between the real and virtual environments. While an embodiment of the invention may employ the B5GEMINI architecture, no particular DT architecture is required by any embodiment and, as such, the B5GEMINI architecture is presented by way of example, and not limitation.

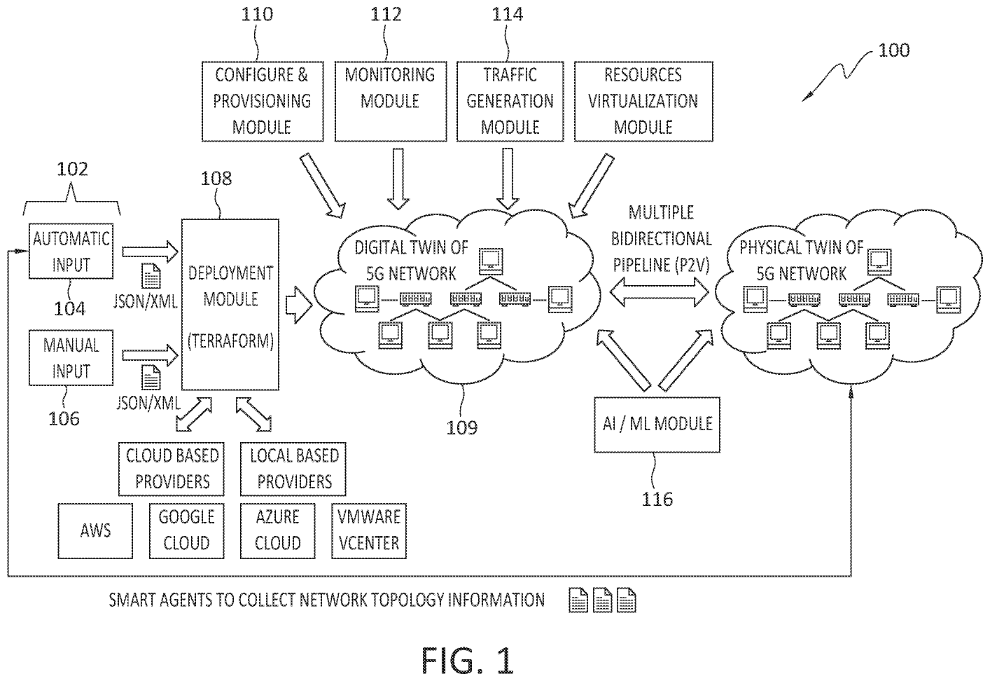

With reference now to FIG. 1, aspects of the B5GEMINI architecture 100 are disclosed. As shown, a system input 102 for DT generation accepts two alternatives, namely automatic entry 104 using smart agents that collect all information needed, and manual entry 106 by operator(s) who manually provide the specification for the DT.

The deployment module 108 is used to oversee the implementation of the virtual infrastructure 109 that will host the DTs. It is based on the Terraform laaS (Infrastructure as a Service) tool, and allows, through different providers, deployment of the infrastructure in any available cloud, such as AWS, Google Cloud, Azure, and IBM, or in its own virtualization infrastructures. This deployment module 108 employs a wide library of virtual machines and Docker containers for provisioning and configuring different DTs implemented using different technologies, such as Kubernetes, and Docker Swarm, for example. The communication between different DTs is performed using virtual links established to communicate the required containers with other devices in the environment.

With continued reference to FIG. 1, a digital twin configuration and provisioning module 110 uses the information collected by smart agents to model the DTs and configure the interconnection to fully simulate the physical network. Further, a network monitoring module 112 controls the activation port-mirroring functionalities to obtain information about the traffic.

A traffic generation and injection module 114 provides a way of injecting traffic in the network-virtualized infrastructure without dealing with actual network and hardware. It can perform session management, registering and de-registering, maintenance of tunnels in the core network, and send data, for example

Finally, the AI/ML module 116 was designed to provide AI components deployed as smart agents. The main idea of this module is to allow the inclusion of new functionalities in B5GEMINI, such as the module presented in this invention. In other words, the original B5GEMINI was designed to be prepared to link to new modules. Further details concerning the B5GEMINI architecture 100 can be found in Mozo.

### D. Bellman-Ford Algorithm

In order to mitigate jamming attacks, it may be useful to define an optimal communication route, also referred to herein simply as a ‘route,’ that avoids the affected nodes. This can be modelled as a graph problem, for which several algorithms, both exact and approximate, are available. The Wireless Routing Protocol (WRP) for example, disclosed in “Murthy, Shree, and Jose Joaquin Garcia-Luna-Aceves. ‘An efficient routing protocol for wireless networks.’ Mobile Networks and applications 1.2 (1996): 183-197” (“Murthy”), which is incorporated herein in its entirety by this reference, is adapted from the Bellman-Ford algorithm.

The Bellman-Ford algorithm initializes the distance to the source i₁ to 0 and all other nodes to infinity. Then for each edge, the algorithm iteratively checks if taking this edge shortens the distance to the destination. In this is the case, the distance is updated to the new lower value. Further details can be found in “Bang-Jensen, Jørgen; Gutin, Gregory (2000). “Section 2.3.4: The Bellman-Ford-Moore algorithm”. Digraphs: Theory, Algorithms and Applications (First ed.). ISBN 978-1-84800-997-4,” which is incorporated herein in its entirety by this reference.

In WRP, the Bellman-Ford algorithm is used for allowing a routing node to know the length of the shortest path from each its neighbor to every network destination, as disclosed in Murthy. This information is used to compute the shortest path and define the node successor in the path to each destination. The network in the scope of WRP can modelled as an undirected graph G (I, E), in which I corresponds to the set of nodes and E corresponds to the set of links connecting the nodes. In this model, two nodes i₁ and i₂ can be considered neighbors if there is direct radio connectivity between them. When i₁ properly receives and processes a message, it sends a positive acknowledgment indicating the good radio connectivity. If this acknowledgment is not received for a number of times, it may be considered that the connection with this node has been lost.

Each node maintains a distance table, a routing table, a link-cost table and a message retransmission list, as noted in Murthy. The distance table of a node i₁ consists of a matrix that stores the distance to each destination node from each neighbor of i₁, and the predecessor of this neighbor. Each entry of the routing table of a node i₁ contains the destination identifier, the distance to this destination, the predecessor and successor of the chosen shortest path to the destination, and a marker used to update the routing table, as noted in Murthy. The link-cost of a node i₁ lists the cost of relaying information through each neighbor, and the number of periodic updates since i₁ received an error-free message from this neighbor. Finally, the message retransmission list specifies one or more retransmission entries, as noted in Murthy. After processing updates from all its neighbors or detecting a change in a link to a neighbor, node i₁ sends a new update message. By maintaining the information updates, the nodes can define the shortest path to a destination, while avoiding unreachable nodes.

### E. Detailed Aspects of an Example Embodiment

Attention is directed now to a detailed discussion of various aspects of one or more example embodiments. One example embodiment comprises an anti-jamming module, and associated methods and operations, which may be implemented as an extension to the B5GEMINI DT architecture. As noted earlier herein, current jamming-resilient solutions either demand significant network resources of nodes or present a delay on reestablishing the data transmission. Also, DT solutions available provide monitoring tools that aid in the detection of several attacks. Nevertheless, such DT solutions do not implement specific anti-jamming defenses to anticipate attacks neither determine quick responses to deal to such attacks.

By way of contrast, one or more embodiments of the invention are directed to overcoming the limitations of previous solutions, by providing quick response to jamming attacks without demanding extra computational effort for nodes. More specifically, an embodiment of the invention may take advantage of the real-time monitoring provided by the B5GEMINI DT architecture, to assess the current state of a communications network, which may be referred to herein simply as a ‘network’ and also the simulation functionalities to analyze, find the attacks that would affect strongly the transmission, and determine alternative routes to reestablish transmission.

In more detail, one or more embodiments may provide various useful features and aspects. For example, one example embodiment is directed to a DT module that operates to provide jamming attacks resilience. Particularly, the DT module according to an embodiment may operate to infer and anticipate optimal jamming attacks through continuous monitoring in a DT module. As another example, the DT module according to an embodiment may operate to establish, or facilitate the establishment of, optimal defense strategies for minimizing the effects of jamming attacks in an efficient manner prior to the attack so that the network can quickly adapt and reestablish itself when the attack occurs.

### E.1 Overview of an Example Method

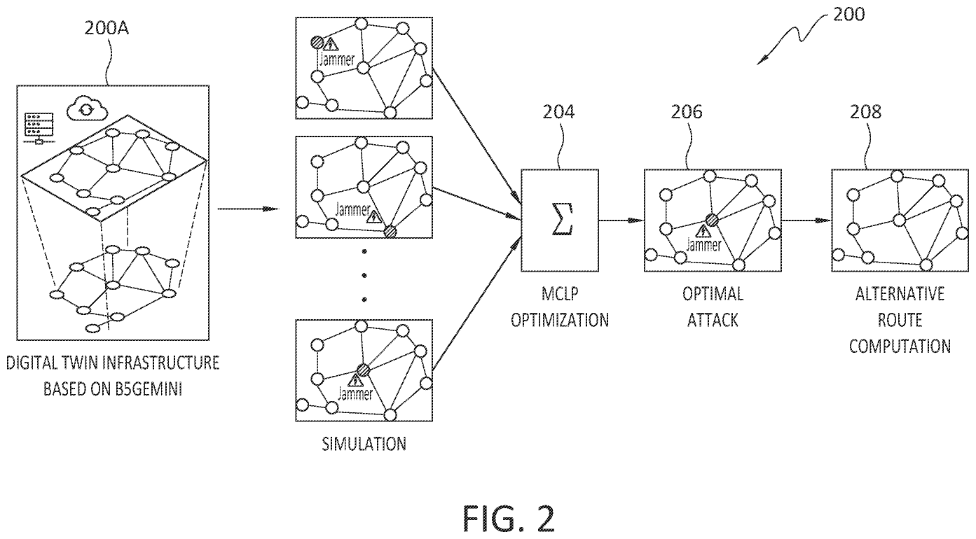

With reference now to FIG. 2, a brief overview of an example method 200 according to one example embodiment is disclosed. Particular details concerning aspects of the method 200 are disclosed below.

As shown the example method 200 may be employed in connection with a DT infrastructure 200A, such as a B5GEMINI DT infrastructure for example. Initially, one or more simulations 202 may be performed of one or more optimal jamming attacks. Next, the information from these simulations may be used to define an optimal placement for the jammer to maximize the attack effects. Solving an optimal jammer placement problem may comprise performing an optimization 204 of an MCLP (Maximal Covering Location Problem) 204. An output of the optimization 204 may comprise an optimal attack 206 that may identify, for example, nodes expected to be adversely affected by the optimal attack 206. Once the optimal attack 206 has been identified, alternate communication routes can be determined 208, taking into account the nodes that are expected to be compromised by the optimal attack 206. When an optimal attack is detected, network communications can then be directed to, and handled by, the alternate routes.

### E.2 Overview of an Example Anti-Jamming Module and Operations

One example embodiment comprises an extension of the B5GEMINI DT architecture. As noted earlier, this architecture comprises a DT solution capable of accurately emulating the behavior of a 5G/6G network. B5GEMINI comprises five primary modules: (1) deployment-provides the implementation of the virtual infrastructure that will host the DTs, (2) DT configuration and provisioning-responsible for modeling each DT and configuring the necessary interconnections to fully simulate the target 5G network functions, (3) network monitoring-monitors the complete operation of all information exchanged within the DT, (4) traffic generation and injection-emulates the operations of user equipment in a real environment and (5) AI/ML Module that provides AI/ML models built, or imported, into the platform. Note that while the B5GEMINI DT architecture is nominally focused on 5G/6G communication networks, it may, in an embodiment, be extended to other types of wireless networks. Likewise, other DT architectures may be extended to 5G/6G, and other, types of wireless networks, according to one or more embodiments.

One example embodiment is directed to an extension of B5GEMINI, namely, a module that comprises an anti-jamming solution, detecting ongoing attacks that were previously anticipated, and implementing quick responses for these attacks minimizing their effects. In an embodiment, an algorithm of this solution comprises two primary stages, and may be triggered every time the state of the network nodes changes or, if too many changes are expected, after a predefine amount of time has elapsed.

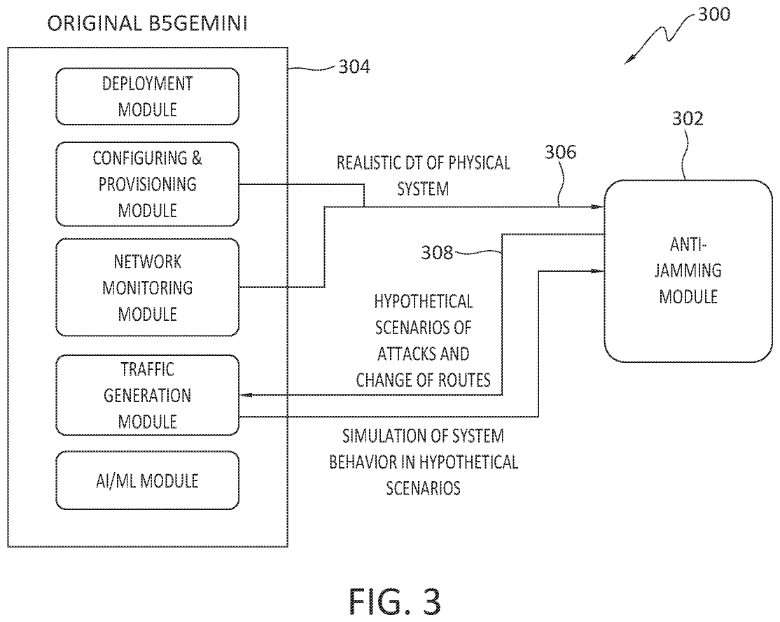

Directing attention now to FIG. 3, discloses an architecture 300 that indicates how an anti-jamming module 302 according to one example embodiment interacts with the modules of B5GEMINI 304. Thus, the anti-jamming module 302 may comprise an extension, at least in terms of functionality, of the base B5GEMINI architecture 304. Particularly, the anti-jamming module 302 may communicate with one or more modules of the B5GEMINI 304 modules, discussed elsewhere herein in connection with FIG. 1, during execution/operation of the anti-jamming module 302.

In an embodiment, the anti-jamming module 302 may operate to [1] anticipate and [2] mitigate, jamming attacks. As noted herein, the algorithm implemented in/by the anti-jamming module 302 may comprise two primary stages, and the execution of the algorithm may be triggered every time the state of the network nodes changes. In an embodiment, the first stage of the algorithm comprises cloning 306, the state of an actual physical network and the nodes of the physical network in order to mirror the current state of the physical entities so as to enable performance of simulated jamming attacks. The cloning 306 may be performed in cooperation with the configuring and provisioning module, and the network monitoring module, of the B5GEMINI architecture 304. The anti-jamming module 302 may provide 308, to the traffic generation module of the B5GEMINI architecture 304 various hypothetical scenarios of attacks, and change of routes relating to those attacks. In response, the traffic generation module may provide, to the anti-jamming module 302, a simulation of system and traffic behavior resulting from the hypothetical scenarios 310 provided by the anti-jamming module 302. This information may then be used by the anti-jamming module 302 to define an optimal attack, and consequently the nodes affected in this hypothetical attack, after which, the anti-jamming module 302 May then determine an optimal route that avoids the affected nodes.

The process described in connection with FIG. 3 may be repeated several times until the ‘k’ most successful attacks are anticipated and the corresponding alternatives routes to handle those attacks are defined. In this way, during the monitoring performed in real-time by other B5GEMINI modules, if one of the anticipated attacks is detected, the alternative route that has been determined for that particular attack may be implemented as a mitigation strategy. One straightforward way to measure the success of an attack is by the number of nodes affected. Nevertheless, according to the context, other measures can be considered, such as node centrality, and information flow, for example.

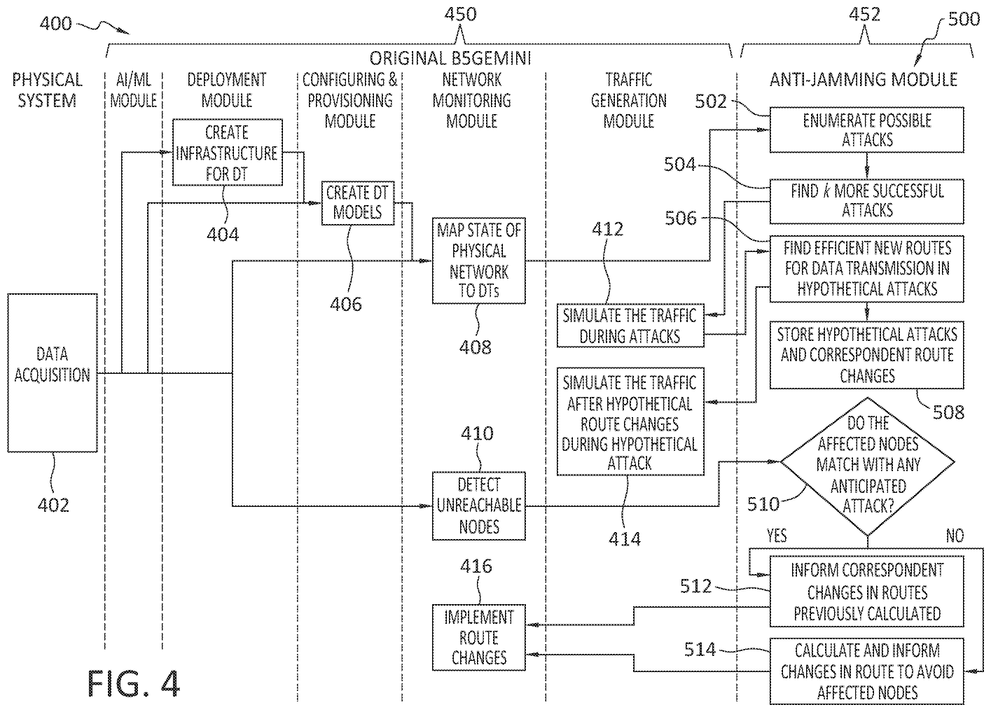

With reference now to FIG. 4, detailed aspects of an example method 400, such as may be implemented in and by the architecture 300 shown in FIG. 3, are disclosed. The example method 400 may begin with the acquisition of data 402 about the configuration and operation of a physical communications network. This data may then be passed from the physical communications network to a B5GEMINI architecture 450. Details concerning some examples of such data are provided in Mozo. As shown, the data may be used for creation 404 of a DT infrastructure, and creation 406 of DT models, by a deployment module and a configuring and provisioning module, respectively. The data, and the DT models/infrastructure may then be used to map 408 the state of the physical communications network to one or more DTs.

The data concerning the configuration and operation of the communications network may be used to detect 410, such as during an attack, any unreachable nodes of the communications network. This information about unreachable nodes may be provided to the anti-jamming module 452. As discussed in more detail below, the anti-jamming module 452 May take various actions based on this information, such as rerouting communications for example.

With continued reference to the example of FIG. 4, various additional operations may be performed in connection with the anti-jamming module 452 and various modules of the B5GEMINI architecture 450, such as the network monitoring module, and the traffic generation module. In particular, the anti-jamming module 452 may perform a method 500 that may begin with the identification 502 of one or more possible attacks that may be expected in the communications network. This identification 502 may be based on the mapping 408 information received from the network monitoring module. Further, ‘k’ additional attacks may be identified 504, as described earlier herein, and information concerning the various attacks provided to the traffic generation module for simulation 412 of network traffic while the hypothetical attacks are occurring.

The simulated network traffic may indicate how the network traffic is expected to behave during the attack. Information concerning the simulated 412 network traffic may be provided to the anti-jamming module 452 which may use that information to identify 506 efficient new hypothetical routes for data transmission when an attack, such as one of the hypothetical attacks, is occurring. This information identifying the new routes, and information concerning the hypothetical attacks, may be stored 508 by the anti-jamming module 452. As well, the route information may also be provided to the traffic generation module which may then simulate 414 the network traffic using the new routes during the hypothetical attack. This simulation 414 may serve as a check to verify the integrity and operation of the new routes.

At some point during a network monitoring process, which may be performed by the network monitoring module of the B5GEMINI architecture 450, one or more nodes of the network may be detected 410 as being unreachable by network communications. The identity, location, and possibly other information, about the unreachable nodes may be provided by the network monitoring module to the anti-jamming module 452. The anti-jamming module 452 may then perform a check 510 to determine if the affected, that is, unreachable, nodes match with the nodes expected to be affected by an anticipated attack.

If the nodes match, indicating that an anticipated attack is occurring, the anti-jamming module 452 may notify 512, possibly in real time as the attack is occurring, the network monitoring module to begin using the route changes that were previously identified. The matching of the nodes may indicate that the attack that is occurring is an optimal jamming attack, and the network monitoring module may then implement 416 the route changes. On the other hand, if the check 510 reveals that the unreachable nodes do not match with an anticipated attack, then the anti-jamming module 452 may then, in response to this information about the unreachable nodes, calculate, and inform the network monitoring module of 514, the route changes to be implemented in order to avoid the affected nodes. The calculated route changes received from the anti-jamming module 452 may then be implemented 416 by the network monitoring module.

In connection with the foregoing, an embodiment of the invention may operate to minimize the effects of jamming attacks since the response time is low, so the most critical, or optimal, attacks are quickly mitigated. Even if there are no alternative routes previously defined for a set of nodes affected by a real attack, and the alternative route must be defined in real-time in a reactive way, the impact of such attack may be low, since if this attack was not anticipated, it is not an optimal attack and as such would not damage the transmission significantly while the reactive defense is being implemented. An embodiment may be especially effective for dealing with constant targeted attacks and for attacks with the highest impacts, since route changes may already have been determined and may be implemented immediately after a determination that an anticipated attack is occurring. In a case in which the attack is not anticipated, an embodiment may still provide a reactive solution, such as by calculating route changes on-the-fly while the attack is occurring, as noted at 514 above.

### E.3 Simulating Optimal Jamming Attacks

With the foregoing discussion in view, further details are now provided concerning the simulation of optimal jamming attacks. As noted earlier, an initial stage of a method according to one embodiment of the invention is to clone the current state of the physical entities, depicted by the monitoring module, to perform simulations of jamming attacks in this context, using the traffic generation and injection module.

Note that, after the information of the state of each network node, especially their respective locations, defining the optimal placement for the jammer to maximize the attack effects can be modelled as a Maximal Covering Location Problem (MCLP). Details concerning an MCLP are disclosed in “Zarandi, MH Fazel, Soheil Davari, and SA Haddad Sisakht. “The large scale maximal covering location problem.” Scientia Iranica 18.6 (2011): 1564-1570,” which is incorporated herein in its entirety by this reference.

In general, solving an MCLP may comprise defining an optimal location of a number of facilities on a network in such a way that the size of the covered population is maximized. A node is covered by a facility if the distance of the node from the facility is less than a given threshold. In the jammer location context, this threshold may be defined according to the hearing range of nodes. The hearing range of a considered example receiver ‘Node A’ specifies the area or range within which potential transmitters, whether legitimate or jammers, can deliver signals, such as messages, to ‘Node A.’

Jamming signals are attenuated according to the distance within a circle centered at the jammer called Noise Level Boundary (NLB), as disclosed in “Liu, Zhenhua, et al. ‘Exploiting jamming-caused neighbor changes for jammer localization.’ IEEE Transactions on Parallel and Distributed Systems 23.3 (2011): 547-555” (“Liu”), which is incorporated herein in its entirety by this reference. It is noted that jamming signals are interference signals that increase the noise in the transmission medium, such as air for example. In other words, a node located within the NLB circle will increase ambient noise, negatively affecting the transmission since the noise exceeds the signal by certain amount, as noted in Liu. There are various exact heuristic and metaheuristic algorithms available to solve MCLPs.

For the purposes of an example embodiment, the problem may be described as follows:

$$Maximize z = {\sum }_{i ∈ I} {a}_{i} {y}_{i}$$

$$Subject to : {y}_{i} = {\sum }_{j ∈ {N}_{i}} {x}_{i} , i ∈ I$$

$${\sum }_{j ∈ J} {x}_{j} = p$$

$$0 \leq {y}_{i} \leq 1 , i ∈ I$$

$${x}_{i} ∈ \{ 0 , 1 \} , j ∈ J$$

where:
i, I are the index and set of nodes,
j, J are the index and set of eligible jammer sites,
aᵢ is the weight of node i,
dᵢⱼ is the shortest distance from node i to jammer at site j,
S is the radius of NLB circle,
Nᵢ{j|dᵢⱼ≤S} are the jammer sites j that are within a distance of S to node i,
p is the number of jammers to be established,
xⱼ is a binary variable that equals one when a jammer is sited at j and zero otherwise, and
yᵢ is the number of jammers that covers node i, that is, are located within S.

In an embodiment, an exact solution may be found by testing all possibilities of jammer locations e selecting the maximum z. Nevertheless, even considering that this problem can be solved using the exact approach mentioned above, this is only one possible option for obtaining a solution. More generally, various other problem solution options may be employed based on the context. For example, in large networks, defining the exact solution for this optimization problem is computationally expensive, so an approximation algorithm, such as a heuristic one for example, may be used.

### E.4 Defining Alternative Routes

With the discussion of FIG. 4, in particular, in view, further details are now provided concerning the definition of alternative communication routes in a communication network. After defining the optimal attack, and consequently the nodes affected in this hypothetical attack, an optimal route avoiding the affected nodes may be determined. Once more, this can be modelled as a graph problem, for which several algorithms, both exact and approximate, are available. The Wireless Routing Protocol (WRP) in Murthy, for example, is adapted from Bellman-Ford algorithm. This protocol considers the distance/cost of transmitting from a node i to a node i₂, which are modelled as edges of the graph, in which each vertex corresponds to a node i∈I.

The primary limitation of the Bellman-Ford algorithm is the high demand for network resources, since a significant amount of data is constantly being broadcast for several nodes. One, non-limiting, alternative to this approach is to use the Bellman-Ford algorithm but instead of maintaining all this data in the nodes, and broadcasting the information when an update is received, centralize this information in the DT platform instead. In this way, the anti-jamming module stores the shortest paths, obtained using the Bellman-Ford algorithm, for variations of the original network graph, by removing nodes that could potentially be the target of an attack.

In an embodiment, a traffic generation and injection module may be used to validate the route to be implemented to handle the supposed attack. This process may be repeated for the first ‘k’ most successful attacks, and these alternative routes stored. Finally, during the real-time execution of the monitoring module, if the communication is interrupted in a set of close nodes, the list of alternative routes may be checked, and the alternative route that avoids such nodes is selected. If there are no such routes, an embodiment may resort to a reactive approach, as disclosed elsewhere herein.

### F. Example Methods

It is noted with respect to the disclosed methods, including the example methods of FIGS. 2-4, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

In the example embodiments disclosed in FIGS. 3 and 4, a method may be cooperatively performed by a DT architecture, and in some particular embodiments, a traffic generation module and network monitoring module, in cooperation with an anti-jamming module. However, no particular allocation of functions included or implied by such methods is necessarily required.

### G. Further Example Embodiments

Following are some further example embodiments of the invention. These are presented only by way of example and are not intended to limit the scope of the invention in any way.

Embodiment 1. A method, comprising: receiving, by an anti-jamming module, information indicating that nodes of a communication network are unreachable; determining, by the anti-jamming module, whether the nodes match with nodes expected to be affected by an anticipated jamming attack; when the nodes match with the nodes expected to be affected by the anticipated jamming attack, providing, by the anti-jamming module, communication network route changes to a network monitoring module; and when the nodes do not match with the nodes expected to be affected by the anticipated jamming attack, calculating, by the anti-jamming module, other communication network route changes, and providing the other communication network route changes to the network monitoring module.

Embodiment 2. The method as recited in any preceding embodiment, wherein the anticipated jamming attack is an optimal jamming attack that was determined through use of a clone of the communication network on a digital twin architecture.

Embodiment 3. The method as recited in any preceding embodiment, wherein the communication network route changes are generated prior to detection of the anticipated jamming attack.

Embodiment 4. The method as recited in any preceding embodiment, wherein the information indicating that the nodes of the communication network are unreachable is received while a jamming attack is underway.

Embodiment 5. The method as recited in any preceding embodiment, wherein the communication network route changes, and the other communication network route changes, do not include the unreachable nodes.

Embodiment 6. The method as recited in any preceding embodiment, wherein the communication network is a wireless communication network.

Embodiment 7. The method as recited in any preceding embodiment, wherein the communication network route changes were identified, prior to receipt of the information concerning the nodes that are unreachable, based on one or more hypothetical jamming attacks executed on a clone of the communication network in a digital twin architecture.

Embodiment 8. The method as recited in any preceding embodiment, wherein when the nodes do not match with the nodes expected to be affected by the anticipated jamming attack, a jamming attack that caused the nodes to be unreachable is a non-optimal attack.

Embodiment 9. The method as recited in any preceding embodiment, wherein the anticipated jamming attack was identified by optimization of a maximal covering location problem.

Embodiment 10. The method as recited in any preceding embodiment, wherein communications in the communication network are rerouted based on either the communication network route changes, or the other communication network route changes.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

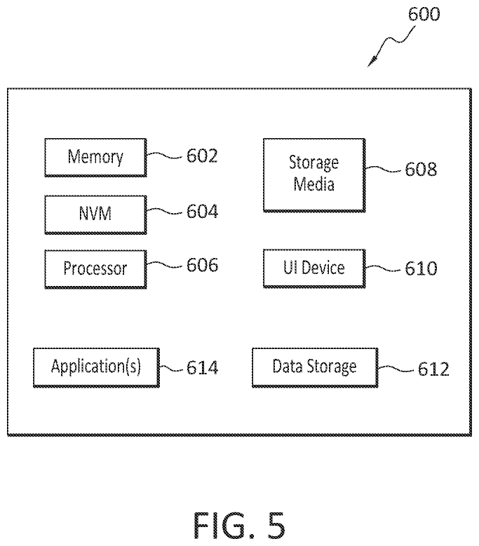

With reference briefly now to FIG. 5, any one or more of the entities disclosed, or implied, by FIGS. 104, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by an anti-jamming module, information indicating that nodes of a communication network are unreachable;
determining, by the anti-jamming module, whether the nodes match with nodes expected to be affected by an anticipated jamming attack;
when the nodes match with the nodes expected to be affected by the anticipated jamming attack, providing, by the anti-jamming module, communication network route changes to a network monitoring module; and
when the nodes do not match with the nodes expected to be affected by the anticipated jamming attack, calculating, by the anti-jamming module, other communication network route changes, and providing the other communication network route changes to the network monitoring module.

2. The method as recited in claim 1, wherein the anticipated jamming attack is an optimal jamming attack that was determined through use of a clone of the communication network on a digital twin architecture.

3. The method as recited in claim 1, wherein the communication network route changes are generated prior to detection of the anticipated jamming attack.

4. The method as recited in claim 1, wherein the information indicating that the nodes of the communication network are unreachable is received while a jamming attack is underway.

5. The method as recited in claim 1, wherein the communication network route changes, and the other communication network route changes, do not include the unreachable nodes.

6. The method as recited in claim 1, wherein the communication network is a wireless communication network.

7. The method as recited in claim 1, wherein the communication network route changes were identified, prior to receipt of the information concerning the nodes that are unreachable, based on one or more hypothetical jamming attacks executed on a clone of the communication network in a digital twin architecture.

8. The method as recited in claim 1, wherein when the nodes do not match with the nodes expected to be affected by the anticipated jamming attack, a jamming attack that caused the nodes to be unreachable is a non-optimal attack.

9. The method as recited in claim 1, wherein the anticipated jamming attack was identified by optimization of a maximal covering location problem.

10. The method as recited in claim 1, wherein communications in the communication network are rerouted based on either the communication network route changes, or the other communication network route changes.

11. A non-transitory storage medium having stored therein instructions that are executable by one or more hardware processors to perform operations comprising:
receiving, by an anti-jamming module, information indicating that nodes of a communication network are unreachable;
determining, by the anti-jamming module, whether the nodes match with nodes expected to be affected by an anticipated jamming attack;
when the nodes match with the nodes expected to be affected by the anticipated jamming attack, providing, by the anti-jamming module, communication network route changes to a network monitoring module; and
when the nodes do not match with the nodes expected to be affected by the anticipated jamming attack, calculating, by the anti-jamming module, other communication network route changes, and providing the other communication network route changes to the network monitoring module.

12. The non-transitory storage medium as recited in claim 11, wherein the anticipated jamming attack is an optimal jamming attack that was determined through use of a clone of the communication network on a digital twin architecture.

13. The non-transitory storage medium as recited in claim 11, wherein the communication network route changes are generated prior to detection of the anticipated jamming attack.

14. The non-transitory storage medium as recited in claim 11, wherein the information indicating that the nodes of the communication network are unreachable is received while a jamming attack is underway.

15. The non-transitory storage medium as recited in claim 11, wherein the communication network route changes, and the other communication network route changes, do not include the unreachable nodes.

16. The non-transitory storage medium as recited in claim 11, wherein the communication network is a wireless communication network.

17. The non-transitory storage medium as recited in claim 11, wherein the communication network route changes were identified, prior to receipt of the information concerning the nodes that are unreachable, based on one or more hypothetical jamming attacks executed on a clone of the communication network in a digital twin architecture.

18. The non-transitory storage medium as recited in claim 11, wherein when the nodes do not match with the nodes expected to be affected by the anticipated jamming attack, a jamming attack that caused the nodes to be unreachable is a non-optimal attack.

19. The non-transitory storage medium as recited in claim 11, wherein the anticipated jamming attack was identified by optimization of a maximal covering location problem.

20. The non-transitory storage medium as recited in claim 11, wherein communications in the communication network are rerouted based on either the communication network route changes, or the other communication network route changes.
